(19) United States
(12) Patent Application Publication
(10) Pub. No.: US 2005/0072677 A1
(43) Pub. Date: Apr. 7, 2005

(54) Dielectric particle focusing

(75) Inventors: Peter R.C. Gascoyne, Bellaire, TX (US); Jody V. Vykoukal, Houston, TX (US)

Correspondence Address: FULBRIGHT & JAWORSKI L.L.P., 600 CONGRESS AVE., SUITE 2400, AUSTIN, TX, 78701, US

(73) Assignee: Board of Regents, The University of Texas System

(21) Appl. No.: 10/781,057

(22) Filed: Feb. 18, 2004

Related U.S. Application Data
(60) Provisional application No. 60/448,672, filed on Feb. 18, 2003.

(51) Int. Cl. G01N 27/453

(52) U.S. Cl. 204/547; 204/643

(57) ABSTRACT

Methods and apparatuses for particle focusing. Particles are focused within a fluid-flow channel using dielectrophoretic forces from electrodes disposed within the fluid-flow channel, and the focused particles can be detected with an optical detector.

This application claims priority to, and incorporates by reference, U.S. Provisional Patent Application Ser. No. 60/448,672, which was filed Feb. 18, 2003.

### BACKGROUND OF THE INVENTION

1. Field of the Invention

The present invention relates generally to cytometry. More particularly, the invention relates to the use of dielectrophoresis (DEP) to focus particles for use in cytometry.

2. Background

Cytometry includes powerful and important methods that can allow individual cells suspended in a fluid medium to be characterized by multiple parameters simultaneously. It includes important and powerful methods for cell analysis that find wide use in bio-industrial, research and clinical diagnostic applications.

In essence, a cytometer includes a fluid flow path that carries suspended cells or particles through one or more illumination sources and optical detectors. Radiation emanating from the particles as they intersect beams of light from the sources is analyzed after being measured in the detectors. The radiation may be scattered light of the same wavelength as the beam(s) or fluorescence of a different wavelength from the interaction of photons in the light beam(s) with fluorophores in the particles. Signals from the sensors are collected, displayed, and analyzed to reveal parameters of interest of the particles being examined. For example, it is a common practice to label cells with fluorescent antibodies or dyes to enable one or more cellular parameters of interest to be correlated with light scatter. In this way the cells may be identified or otherwise characterized.

In order for the strength of the signals to accurately reflect the parameters of interest, cells or other particles must intersect a small region of space, as they are carried by fluid flow, that is aligned accurately with respect to the illuminating light beam(s) and detector(s). In practice, this cannot be accomplished by passing the particles though a very small flow channel because a small enough channel (of the order of 20 microns in diameter) is easily blocked by dust or debris that is found in typical samples.

A challenge in design, therefore, is providing a means to ensure that particles and cells pass through a small measurement zone without using channels that can be blocked by samples. The usual approach to solving this challenge is to use hydrodynamic focusing. In this method, the sample of interest is fed out of a tube having a diameter of perhaps 200 microns into the center of a stream of medium having a diameter of perhaps 3 mm. In this way, the sample stream becomes surrounded by a wider, annular column of carrier medium called the “sheath flow”. This entire column of fluid comprising the sheath flow and the central sample stream is then passed through a cone-shaped restriction which compresses it to perhaps 200 microns in diameter. The sample stream becomes compressed proportionately with the sheath flow, and the particles of interest are thereby focused into a stream of no more than 20 microns in diameter at the core of the compressed fluid column.

In addition to laminar flow effects, turbulent boundary drag effects may be used to enhance this compression of the sample stream. The compressed column then flows though the optical illumination and detection system which normally has additional, mechanical provisions for alignment. In this way, particles and cells can be reliably made to pass within 10 microns of the optical illumination and detection region while allowing the flow channel to be many tens or even hundreds of microns in diameter and therefore impervious to fouling. Furthermore, because the sample stream is very narrow and is located at the core of the sheath flow, sample particles are carried at an essentially uniform velocity and are largely unaffected by flow velocity gradients that may be present in the entire fluid column as a result of laminar flow effects, for example. Having particles move through the optical detector at uniform velocity is advantageous for ensuring uniformity in signal processing.

While it successfully locates particles in the optimum measurement zone and ensures a constant velocity through the measurement system, the hydrodynamic focusing approach has several disadvantages. For example, it demands a sophisticated system for controlling the sheath flow and a reservoir for the sheath flow medium. A reservoir is required for the sheath flow medium, which also has to be supplied and kept free of dust and bacteria. The optical system is large and prone to the effects of thermal expansion and vibration on alignment. All of these systems are prone to electrical drift and to breakdown. Further, they require constant alignment and preventative maintenance by skilled personnel. Finally, these technologies are bulky, very heavy, and unsuitable for portable applications.

The referenced shortcomings are not intended to be exhaustive, but rather are among many that tend to impair the effectiveness of previously known techniques; however, those mentioned here are sufficient to demonstrate that methodology appearing in the art have not been altogether satisfactory and that a significant need exists for the techniques described and claimed in this disclosure.

### SUMMARY OF THE INVENTION

Particular shortcomings of the prior art are reduced or eliminated by the techniques discussed in this disclosure.

In one respect, the invention involves a system including a fluid flow channel, a plurality of electrodes, and a detector. The flow channel is configured to house a flow stream of a fluid containing a suspension of particles. The electrodes are coupled to the fluid flow channel and is configured to become energized by an AC signal to focus the particles within a region of the flow stream of the fluid using dielectrophoresis forces. The detector observes the particles after they have been focused.

In another respect, the invention involves an apparatus including electrodes and a fluid flow channel. The electrodes are coupled to opposing walls of the fluid flow channel and are configured to generate negative dielectrophoretic forces that focus flowing particles to the center of the fluid flow channel.

In another respect, the invention involves a method for analyzing particles. A suspension of particles is flowed in a suspending fluid along a channel. AC electric signals from a signal generator are applied to electrodes coupled to the channel. Particles are deflected to a narrow region of the fluid by dielectrophoretic forces imposed on the particles by the electrical signals applied to the electrodes. The particles are detected by a detector disposed downstream of at least one electrode to analyze the narrow region.

In another respect, the invention involves a method. A suspension of flowing particles in a channel are focused to a first narrow region in the channel by negative dielectrophoretic forces generated by electrodes coupled to the channel. The particles are then focused to a second narrow region.

As used herein, “cytometer” refers to any cytometry system including but not limited to a flow-cytometer. As used herein, a “particle” refers to any discernible component of a sample. In a preferred embodiment, “particles” refer to cells within a sample. As used herein, a “narrow” region simply refers to a region smaller than a sheath flow. In one embodiment, narrow is less than 200 microns in diameter. In a preferred embodiment, narrow is 20 microns or less in diameter. However, as will be understood by those having ordinary skill in the art, narrow is a relative term and simply connotes, in this application, that particles are focused from a certain region into a smaller (i.e., “narrow”) region. This focusing occurs, in embodiments of this disclosure, through the use of dielectrophoresis. As used herein, “coupled” includes direct and indirect connections.

Other features and associated advantages will become apparent with reference to the following detailed description of specific embodiments in connection with the accompanying drawings.

### BRIEF DESCRIPTION OF THE DRAWINGS

The techniques of this disclosure may be better understood by reference to one or more of these drawings in combination with the detailed description of illustrative embodiments presented herein. Identical or similar elements may use the same element number. The drawings are not necessarily drawn to scale.

FIG. 1 is a schematic diagram of a micro-flow cytometer according to embodiments of this disclosure.

FIG. 2 is an optical micrograph of an etched circular channel with electrode arrays according to embodiments of this disclosure.

FIG. 3 is a schematic diagram of a micro-flow cytometer system according to embodiments of this disclosure.

FIG. 4A is a top view of particles repelled from the tips of planar electrodes according to embodiments of this disclosure.

FIG. 4B is a side view of particles repelled by fringing fields above a plane surface across which are deployed planar electrodes, according to embodiments of this disclosure.

FIG. 5 is a top view of an electrode array according to embodiments of this disclosure.

FIG. 6 is a top view of a cytometer including an electrode array that provides two dimensional focusing, according to embodiments of this disclosure. The shorter electrodes at left focus particles in the plane of the electrodes; the long electrodes at right repel particles out of the plane of the electrodes.

FIGS. 7A and 7B show a top view and a side view of a cytometer.

FIGS. 8A and 8B show annular electrode array configurations according to embodiments of this disclosure.

FIG. 9 shows a micro-flow cytometer according to embodiments of this disclosure.

FIG. 10 shows an octupole electrode array configuration according to embodiments of this disclosure.

FIGS. 11 and 11B show expected cell distribution profiles as the sample is carried through the electrode array by fluid flow according to embodiments of this disclosure. Repulsive DEP forces focus the cells to the center of the fluid ready for optical measurements.

FIG. 12 show a schematic diagram of a cytometer with a feedback system.

### DESCRIPTION OF ILLUSTRATIVE EMBODIMENTS

Shortcomings of conventional technology are addressed by the techniques of this disclosure. In particular, the techniques of this disclosure allow particles to be effectively focused in a robust manner without the accompanying disadvantages mentioned above. A micro-flow cytometer operating using the techniques of this disclosure is more flexible, much more robust, far easier to operate, and inexpensive when compared to today's bench-top cytometers.

An important enabling technology in a micro-cytometer according to this disclosure involves (a) the use of a relatively-straightforward dielectrophoretic method for focusing a stream of cells or other particles into coincident light excitation and measurement zones and (b) the use of integrated optical components that form part of the flow chamber.

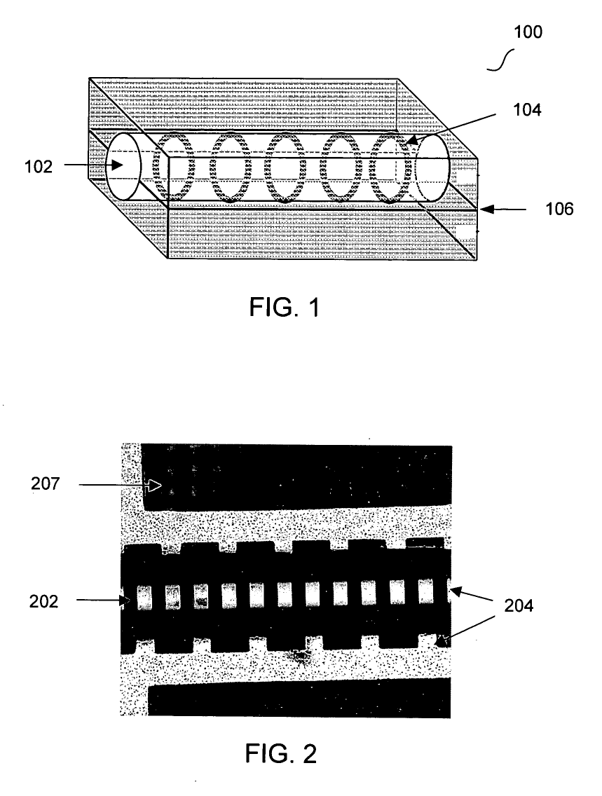

In one embodiment, a micro-cytometer 100 on a silicon (Si) wafer 106 may focus cells to the center region of a micro-channel 102 by a negative dielectrophoretic force generated by AC fringing fields from microelectrodes 104, as illustrated by FIG. 1. The formation of a circular micro-channel, such as micro-channel 202 may be formed by isotropic etching of a glass 207 and silicon wafer with a subsequent wafer bonding process, as shown in FIG. 2. A chromium/gold (Cr/Au) layer may be deposited and patterned into electrode arrays 204 on the micro-channel 202.

An optical detector including but not limited to, an avalanche diode, may be fabricated on the silicon wafer below the microchannel downstream of the focusing region. An optical fiber may be used to couple 470 nm excitation from an ultra-bright blue light emitting diode (LED) to the flow. While flowing through the detector and exposed to the excitation, a fluorescein tagged to the particle can emit at a wavelength of 520 nm. The fluorescence may be collected by the optical detector. To block the excitation wavelength, a thin film long-pass interference filter with a cut-off wavelength at 495 nm may be deposited on the detector.

Additionally, different types of detectors may be utilize to characterize the particles. In one embodiment, the optical detector may include, but is not limited to, an impedance detector where the impedance detector may be coupled to the fluid flow channel and adapted to indicate the location of particles or an individual particle and which can measure properties of the particles such as, but not limited to, conductance. In another embodiment, a detector may not be needed in the cytometer system. In such an embodiment, one may simply take advantage of dielectrophoretic focusing. The focusing can be used as a preliminary step for a vast number of applications as will be understood by those of ordinary skill in the art.

Further, integration of an optical system with the dielectrophoretic focusing system may provide immunity to thermal effects and vibration and, therefore, permanent system alignment. Using the techniques described above and in the accompanying figures, one may readily achieve a single chip micro-cytometer that requires neither complicated fluidic controls nor external optical components. The entire system may be just a few cubic centimeters in volume, realizing the possibility of portable and in-line cytometers. The micro-cytometer may be used in any number of cytometer applications including, but not limited to blood cell profiling and tumor cell detection.

Using the dielectrophoresis approach, cell and particle focusing may be accomplished within a cytometer without the need for sheath flow. In this way, a mechanically more simple approach to cytometry is provided that accurately locates particles within a sample stream while eliminating the need for a sheath medium, a sheath medium reservoir, sheath flow control, and associated supplies and maintenance. Furthermore, the relative simplicity of the techniques of this disclosure allow them to be readily micro-fabricated and integrated into a fluidic chip, allowing a flow cytometer to be miniaturized and incorporated as a measurement device within other instrumentation.

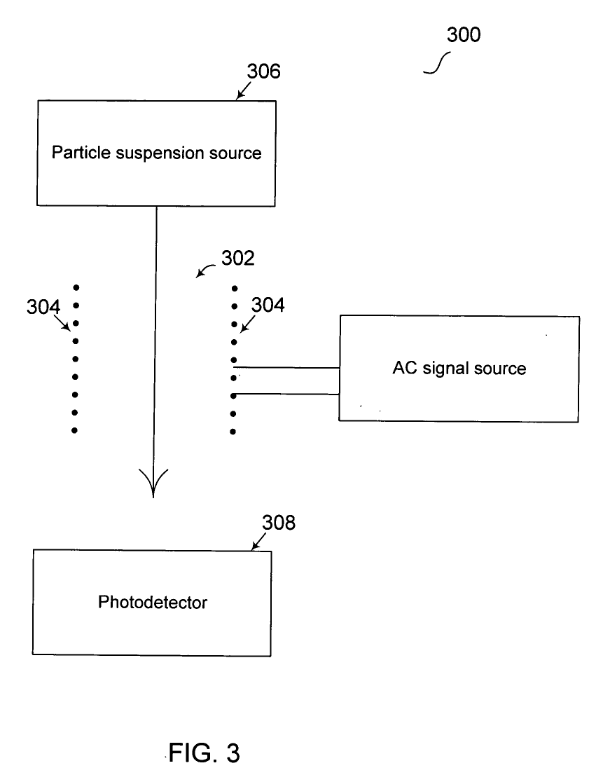

In one embodiment, a cytometer 300 may include a fluid flow channel 302 with wall(s) 304 along which are disposed one or more electrodes or arrays of electrodes energized by at least one AC signal provided by a means to generate such AC signal(s), as illustrated in FIG. 3. Particles in a suspending fluid are introduced from a sample source 306 coupled to the fluid flow channel 302, and may flow through the channel. The electrodes may be configured to impose inhomogeneous electric fields on particles in the channel as a result of the AC signals that are applied to the electrodes. The inhomogeneous electric fields may cause repulsive dielectrophoretic forces to act on the particles within the channel, causing the particles to be repelled from the electrodes. At least one optical sensor, such as photodetector 308, may be configured downstream from at least one electrode to observe the particles in the channel.

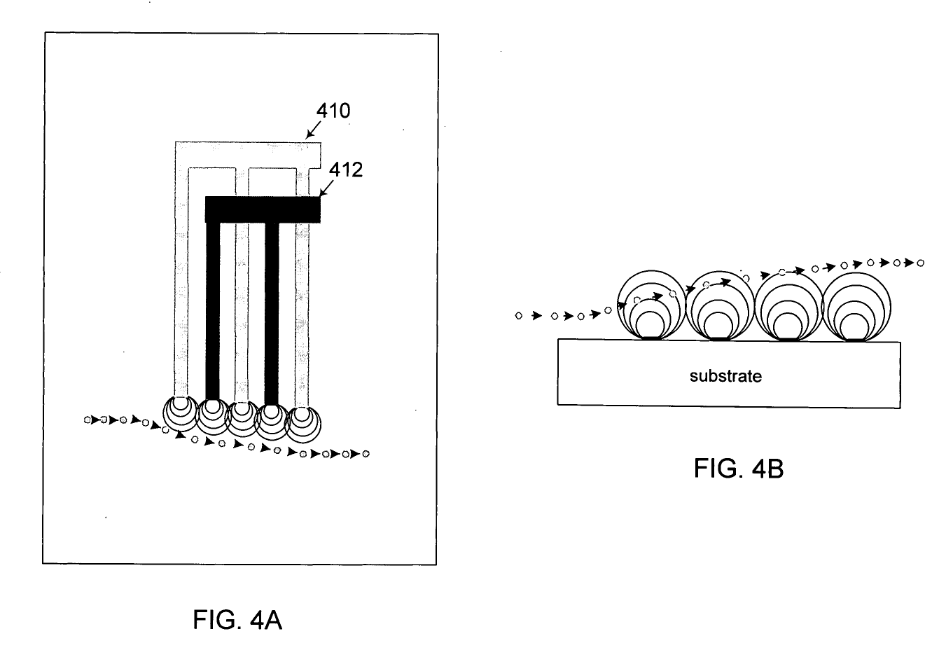

The electrodes that surrounds the fluid flow channel may be adapted to align the particles with respect to an illumination source and an optical sensor. For example, referring to FIGS. 4A and 4B, electrodes 410 and 412, coupled to an in-phase AC signal and a 180° out-of-phase AC signal respectively, may provide a negative dielectrophoretic force onto the particles. The particles may repel away from the tips of the electrodes and towards the center of the fluid flow channel. The force maintains the particles in alignment allowing each particle to be observed by an optical detector within the cytometer.

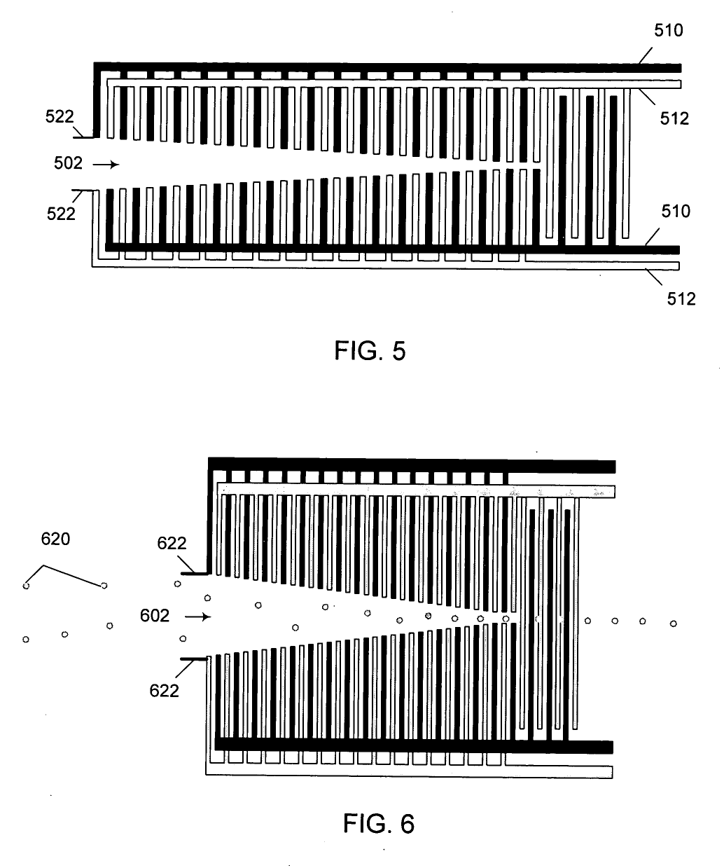

The electrodes that are disposed within the fluid flow channel may be configured in numerous arrangements for focusing the particles suspended in a fluid. In one embodiment, the electrodes may be configured in a flat array where the electrodes may comprise different lengths and may extend into a fluid flow channel 502. In particular, the flat array configuration provides two similar planar electrodes mounted on opposing walls of the fluid flow channel 502. The flat array configuration may provide a two dimensional focusing of the particles, as illustrated in FIG. 5. Towards inlet port 522, where the particle stream may enter the fluid flow channel 502, the electrodes may be shorter in length to focus the particles through the plane of channel 502. As the particles continue down the fluid flow channel 502, the electrodes may become longer in length to align the particles. In particular, the electrodes may provide negative dielectrophoretic (DEP) force which propels the particles into a lateral and then vertical alignment in the center of the flow channel 502. After the alignment of the particles and prior to repelling the particles towards the optical sensor(s), the electrodes may extend from one wall 504 of the fluid flow channel 502 to the other to maintain the alignment of the particles. For example, referring to FIG. 6, particles 620 may enter the fluid flow channel 602 via inlet port 622. As the particles flow through the fluid flow channel 602, the configuration of electrodes focuses the particles from random placements in the suspension fluids to a more focus and eventual alignment of the particles within the plane of the electrodes. The closer the placement of an electrode on one wall of the fluid flow channel 602 to a corresponding electrode on the opposite wall, the more focused the particles become within the channel 602.

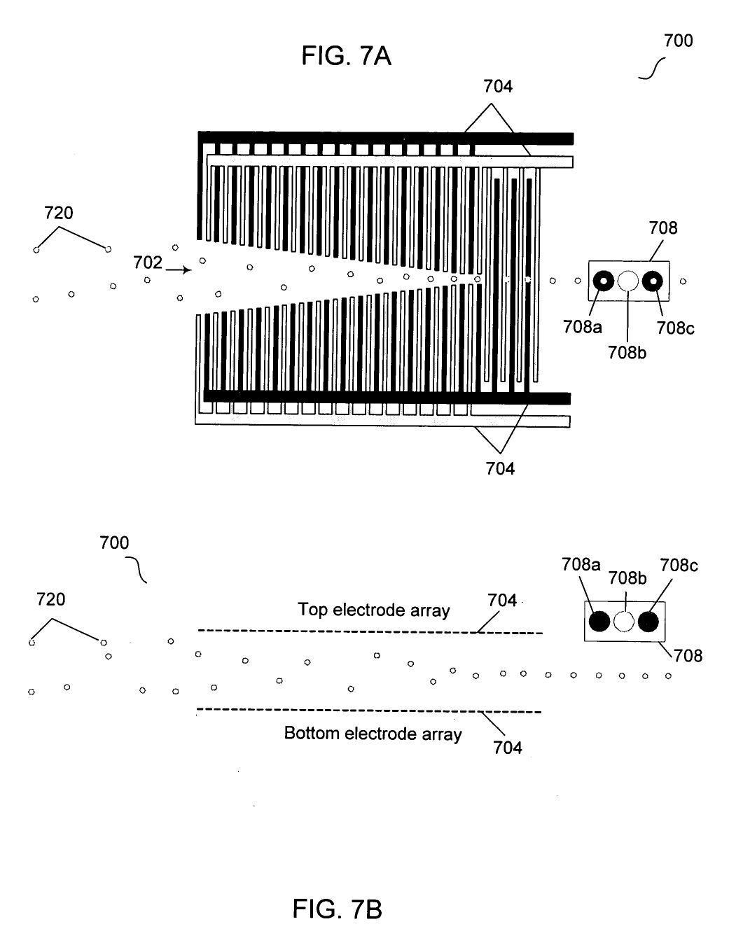

The alignment of the particles may allow optical detectors to observe the characteristics of each particle passing through the fluid flow channel. Referring to FIGS. 7A and 7B, cytometer 700 may include a flat array electrode configuration, where the electrodes are mounted on opposing walls of a fluid flow channel 702 for focusing and vertically aligning particles 720 passing through fluid flow channel 702. Additionally, cytometer 700 may include at least one fluorescence detector 708 which may be adapted to recognize the fluorescence emitted from the fluorescein tagged particles 720. In one embodiment, each particle may be tagged with fluorescein which may emit a particular wavelength. The optical detector 708 may include a plurality of wavelength detectors, 708a, 708b, and 708c, where each wavelength detector may be adapted to recognize a specific wavelength. Accordingly, wavelength detector 708a may recognize and characterize each particle flowing through the channel.

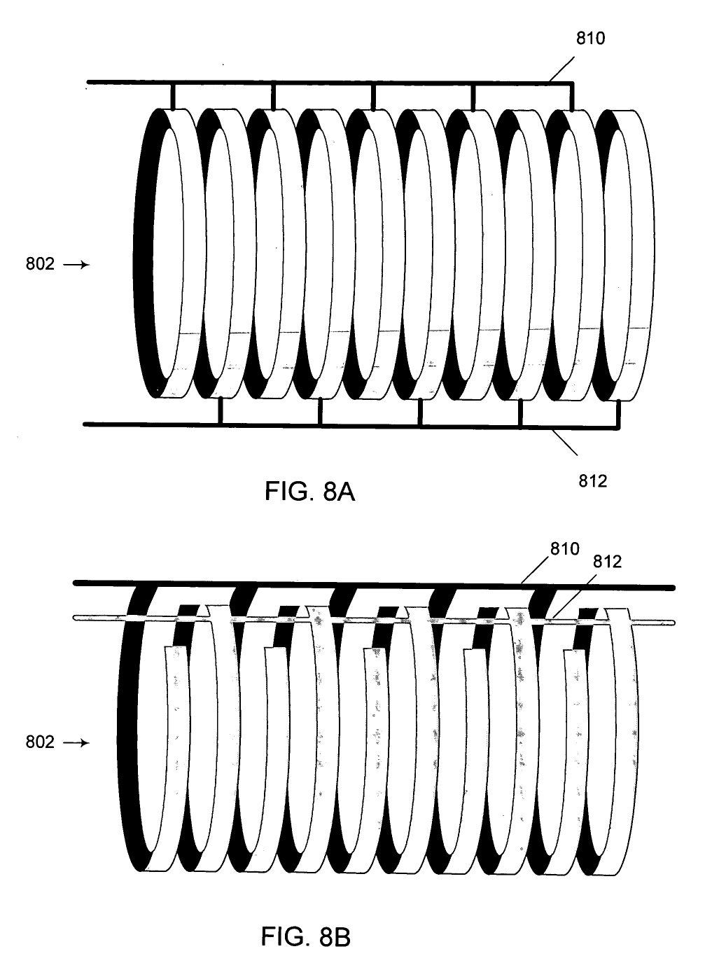

In another embodiment of the invention, the electrodes may be arranged in an annular array configuration, as illustrated in FIGS. 8A and 8B. Each electrode ring may be coupled to at least one AC signal (810 or 812), in which one of the AC signal may be 180° out-of-phase. Referring to FIG. 8A, an embodiment of the annular array configuration is shown where a first AC signal 810 may be located in the upper plane of fluid flow channel 802 and a second AC signal 812, 180° out-of-phase from signal 810, may be located in the bottom plane of channel 802. Similarly, FIG. 8B illustrates an annular array configuration where AC signals 810 and 812 may be located in the upper plane of fluid flow channel 802. However, it is noted that the AC signals may also be located in the bottom plane of the fluid flow channel 802 as well. Each electrode ring of the annular array configuration described above may couple to one of the AC signals. In one embodiment, the electrode rings may alternate coupling to AC signals 810 and 812.

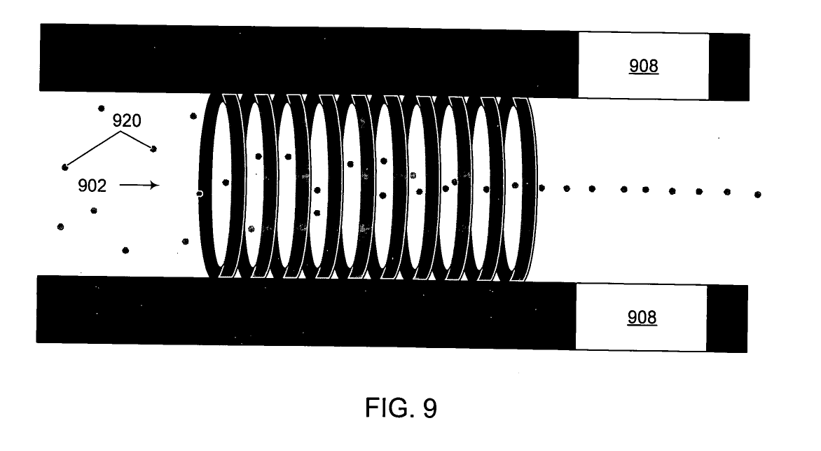

The annular array configuration may be adapted in a cytometer system for characterizing particles in a fluid flow, as illustrated in FIG. 9. Particles 920 may be focused and aligned vertically in the center of the fluid flow channel 902 by a negative DEP force exerted from the electrode rings. In one embodiment, the electrode rings extend from one wall of the fluid flow channel 902 to the other, allowing the particles 920 to flow through each electrode ring. The cytometer 900 may also include at least one AC source coupled to each wall, where the AC source may provide an AC signal to the electrodes. After the particles 920 are aligned, an optional optical sensor, such as photodetector 908, may observe the characteristics of each particle.

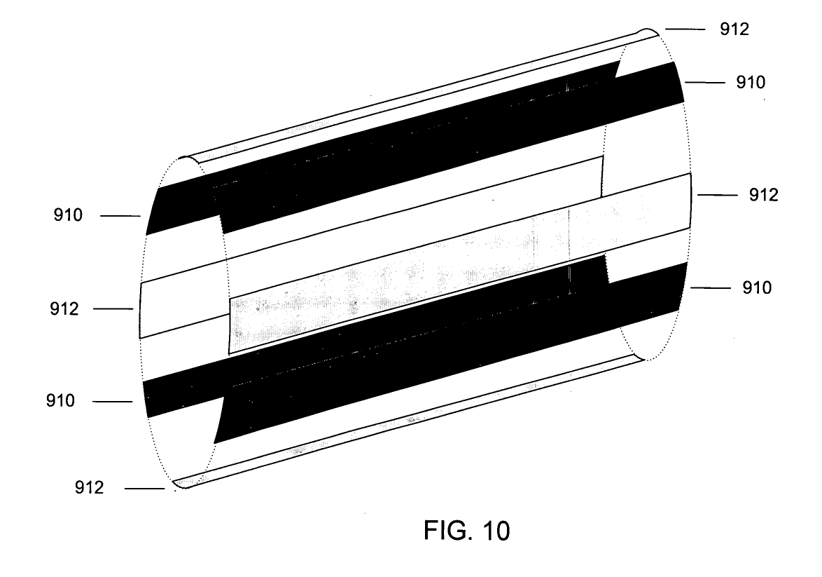

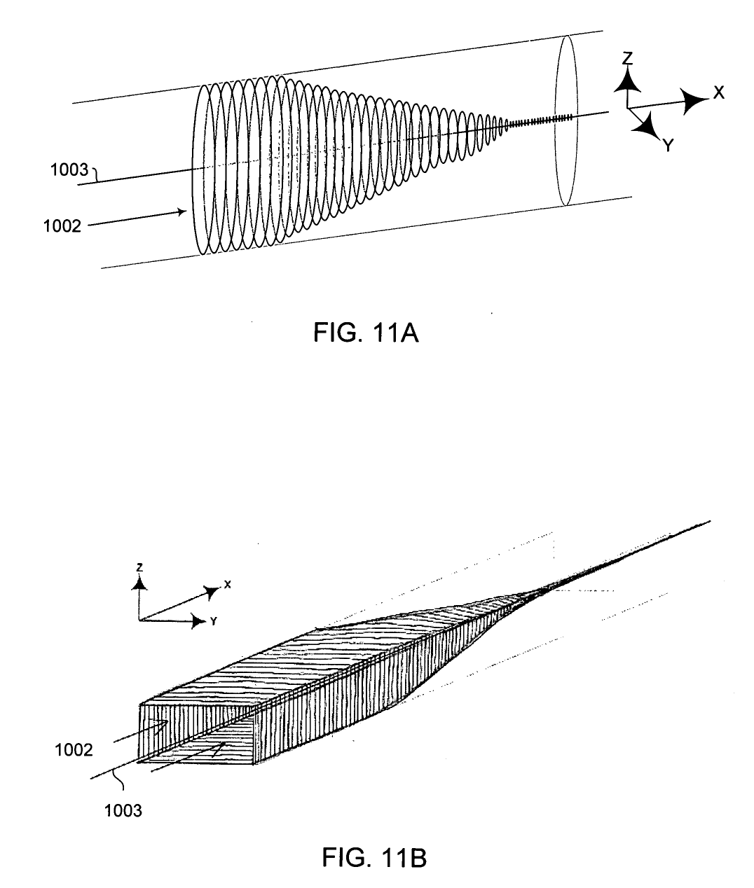

In yet another embodiment of the invention, the electrodes may be arranged in an octupole configuration, as illustrated in FIG. 10. The octupole configuration may include four electrodes 910, coupled to an in-phase AC signal (not shown), alternating with four electrodes 912 coupled to an AC signal (not shown) that may be 180° out-of-phase. As such, the electrodes may exert a negative DEP force upon particles which may flow through the octupole configuration where the electrodes may focus and align the particles for observation.

The following examples are included to demonstrate specific, non-limiting embodiments of this disclosure. It should be appreciated by those of skill in the art that the techniques disclosed in the examples that follow represent techniques discovered by the inventors to function well in the practice of the invention, and thus can be considered to constitute specific modes for its practice. However, those of skill in the art should, in light of the present disclosure, appreciate that many changes can be made in the specific embodiments which are disclosed and still obtain a like or similar result without departing from the spirit and scope of the invention. For instance, techniques of this disclosure may be used with DEP-FFF, magnetic (MAG)-DEP-FFF, with FFF, generalized (gDEP)-FFF, and any other dielectrophoretic methods that can produce forces appropriate for particle focusing.

### EXAMPLE 1

Particles suspended in a fluid are randomly scattered throughout the fluid. In order to detect and characterize each particle, the distribution of the particles must be focused. Referring to FIGS. 11A and 11B, the expected cell distribution through a fluid flow channel 1002 may be focused in the center of the channel about line 1003. As electrodes surrounding the fluid flow channel impose negative dielectrophoretic forces on the particles, the particles repel to the farthest point from the tips of each electrodes, and thus moves towards the center line 1003 of the fluid flow channel 1002. Each particle within the fluid may subsequently be detected and characterized by an optical detector, such as a photodetector within the cytometer.

As such, a cytometer may include a fluid flow channel with at least one inlet port and at least one outlet port and an optical detector downstream of the fluid flow channel. The channel may include walls disposed with one or more electrodes or arrays of electrodes energized by at least one AC signal provided by a an AC signal generator. The electrodes may be adapted to focus and align particles that flow through the channel. For example, particles in a suspending fluid may be introduced from a sample source coupled to the at least one inlet port and may be caused to flow through the channel to the outlet port. The electrodes may be configured to impose inhomogeneous electric fields on the particles as a result of the AC signals through the electrodes. The electric fields may cause repulsive dielectrophoretic forces to act on the particles and may cause the particles to repel away from the electrodes towards the center of the flow channel. The aligned particles may subsequently be viewed by the optical detector.

### EXAMPLE 2

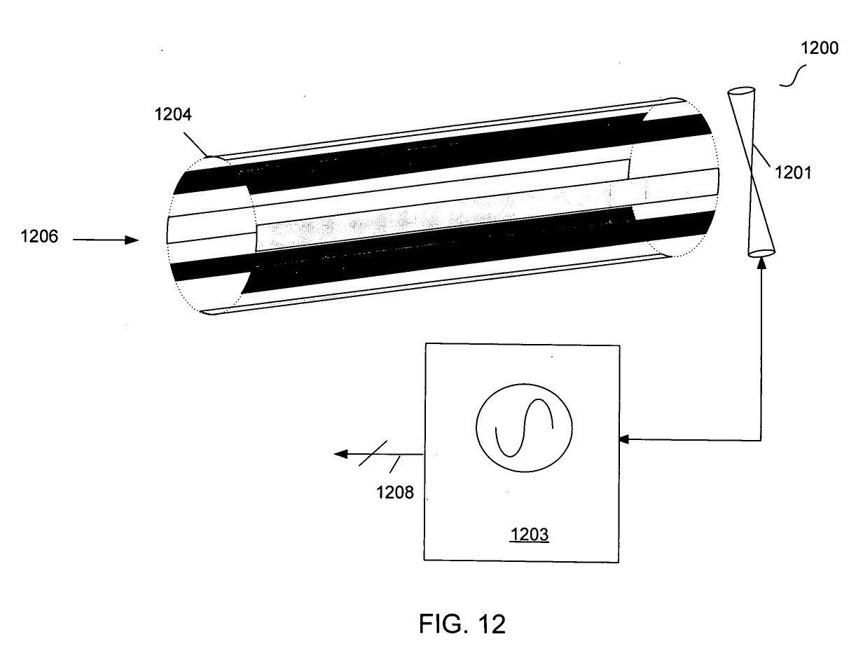

The trajectory of the particles emerging from the fluid flow channel may be not always be optimal for all systems. For example, a detector may be spaced apart from the channel where only a portion of the detector is being utilized to characterize the particles. Thus, the detector may not be able to fully characterize all the particles. FIG. 12 shows a system 1200 including a particle position sensor 1201 coupled to a feedback controller 1203. The system 1200 may also include an electrode array 1204 (e.g., an octupole electrode configuration) for focusing particles flowing through a channel 1206. The particle position sensor 1201 may observe the trajectory of the particles emerging from the channel 1206 and may provide adjustments to the trajectory if deemed necessary to the feedback controller 1203. The feedback controller 1203 may adjust the signals to the electrode array in order to fix the particle focusing trajectory. In one embodiment, the feedback controller 1203 may increase the current flow through the electrodes, causing the alignment of the particles to shift within the fluid flow channel (e.g. moving from the center of the fluid flow to towards the upper plane of the fluid flow channel). The adjustments to the electrodes may be provided by output 1208 coupled to each electrode in the electrode array 1204.

### EXAMPLE 3

The alignment of the particles within the fluid flow channel may allow for detection and characterization of each particle by detectors. In one embodiment, lysing may be performed on particles of a particular characteristic detected by a detector. For example, a plurality of cells may be detected and characterized. In some instances, certain cells, e.g. cancer cells, may be characterized by a detector. An electrical signal may be applied to the cancer cell to electroporate the cancer cells, causing the cells to either leak or burst, leading to a lost of viability. Other cells may contain data needed for further analysis, e.g., DNA material. These cells may temporarily be permeablized, where an electrical signal may be applied to the cell allowing membrane-impermeant agent such as, but not limited to, dyes, antibodies, nucleic acids, and/or drugs to enter the cell. The electroporation of these cells are rapidly reversible, in which the cell membranes are sealed up with the agent(s) inside. As such, there is a selective bursting of the cells depending on the characterization. In one embodiment, the cells may by lysed to introduce agents for treatment or for further analysis. In other embodiments, the cells may be lysed to either leak or completely burst, causing the cell to lose viability.

The electrical signals applied to the cells may occur during the focusing of the cells through the cytometer. Such an embodiment may label the cells as they move through the device. Alternatively, the electrical signals may be applied via a set of electrodes coupled to a detector where the detector determines the type of cells and the electrodes electroporate the cells according to the characterization.

With the benefit of the present disclosure, those having skill in the art will comprehend that techniques claimed herein and described above may be modified and applied to a number of additional, different applications, achieving the same or a similar result. The claims cover all modifications that fall within the scope and spirit of this disclosure.

### References

Each of the following is incorporated by reference in its entirety.
1. U.S. Pat. No. 5,007,732
2. U.S. Pat. No. 5,159,403
3. U.S. Pat. No. 5,506,673
4. U.S. Pat. No. 5,726,364
5. U.S. Pat. No. 5,858,192
6. U.S. Pat. No. 5,888,370
7. U.S. Pat. No. 5,895,764
8. U.S. Pat. No. 5,993,630
9. U.S. Pat. No. 5,993,632
10. U.S. Pat. No. 6,263,745
11. U.S. Pat. No. 6,287,832
12. U.S. Pat. No. 6,294,063.

1. A system, comprising:
a fluid flow channel configured to house a flow stream of a fluid containing a suspension of particles;
a plurality of electrodes coupled to the fluid flow channel, the plurality of electrodes configured to become energized by an AC signal to focus the particles within a region of the flow stream of the fluid using dielectrophoresis forces; and
a detector for observing the particles after they have been focused.

2. The system of claim 1, the system being configured to focus particles in two orthogonal directions.

3. The system of claim 1, the plurality of electrodes comprising a flat array configuration.

4. The system of claim 1, the plurality of electrodes comprising an annular array configuration.

5. The system of claim 1, the plurality of electrodes comprising an octupole configuration.

6. The system of claim 1, the detector comprising an optical detector.

7. The system of claim 1, the detector comprising an impedance detector.

8. An apparatus comprising electrodes coupled to opposing walls of a fluid flow channel, the electrodes being configured to generate negative dielectrophoretic forces that focus flowing particles to the center of the fluid flow channel.

9. The apparatus of claim 8, the electrodes comprising ring electrodes arranged in an annular array configurations.

10. The apparatus of claim 8, the electrodes comprising interdigitated electrodes arranged in flat array configuration.

11. The apparatus of claim 10, the flat array configuration comprising electrodes of varying lengths.

12. The apparatus of claim 8, the electrodes arranged in an octupole configuration.

13. A method, comprising:
flowing a suspension of particles in a suspending fluid along a channel;
applying AC electric signals from a signal generator to electrodes coupled to the channel;
deflecting the particles to a narrow region of the fluid by negative dielectrophoretic forces imposed on the particles by the electrical signals applied to the electrodes; and
detecting the particles by a detector disposed downstream of at least one electrode to analyze the narrow region.

14. The method of claim 13, further comprising lysing particles based on characteristics of the particles.

15. The method of claim 14, the step of lysing comprising electroporating the particles to introduce an agent.

16. The method of claim 14, the step of lysing comprising electroporating the particles causing the particles to lose viability.

17. The method of claim 14, the step of lysing further comprising applying a signal to the particles.

18. The method of claim 13, further comprising deflecting the particles based on feedback from the detector.

19. A method, comprising:
flowing particles in a channel;
focusing particles to a first narrow region of the channel using negative dielectrophoretic forces generated by electrodes coupled to the channel; and
focusing the particles to a second narrow region.

20. The method of claim 19, further comprising detecting the particles.

21. The method of claim 20, where detecting comprises optical detecting.

22. The method of claim 19, where the second region is determined using feedback.
